(19) United States
(12) Patent Application Publication
(10) Pub. No.: US 2025/0185798 A1
(43) Pub. Date: Jun. 12, 2025

(54) ELECTRIC TOOTHBRUSH WITH BRUSHING CONTROL

(71) Applicant: CONCEPTEETH, VALBONNE (FR)

(72) Inventors: Thierry André Christian VALLET, LA FOUILLOUSE (FR); Eric Marcel Maurice BRUYAT, VENCE (FR)

(21) Appl. No.: 18/846,242

(22) PCT Filed: Mar. 15, 2023
(86) PCT No.: PCT/FR2023/050352

§ 371 Date: Sep. 12, 2024

(30) Foreign Application Priority Data
Mar. 18, 2022 (FR) FR2202398

(51) Int. Cl. A46B 15/00; A46B 9/04; A46B 13/00; A46B 13/02; A46B 17/08; A61C 17/26

(52) U.S. Cl. CPC A46B 15/0012; A46B 9/04; A46B 13/006; A46B 13/026; A46B 15/0006; A46B 15/0008; A46B 15/0038; A46B 17/08; A61C 17/26

(57) ABSTRACT

Electric toothbrush (1) comprising an electric motor as well as a brushing organ (3) of the teeth connected to said electric motor to be rotated by the latter, said electric toothbrush (1) being characterized in that it comprises a device for measuring an electrical quantity representative of a contact pressure between the brushing organ (3) and the teeth, as well as a processing unit connected to said measurement device to emit a first warning signal when the value of said electrical quantity measured by said measurement device is greater than a predetermined threshold.

Oral hygiene instruments.

### TECHNICAL FIELD

This invention relates to the general technical field of oral hygiene instruments, and more particularly to the field of toothbrushes, especially for human use.

The present invention concerns more particularly an electric toothbrush comprising an electric motor as well as an organ for brushing teeth connected to said electric motor to be rotated by the latter.

### PRIOR TECHNIQUE

It is known electric toothbrushes implementing a motorized brushing organ. These electric toothbrushes generally give satisfaction, because they allow effective brushing, under conditions particularly comfortable for the user since the implementation of a motorization makes it possible to reduce the gestures to be carried out.

These known electric toothbrushes nevertheless have serious drawbacks.

Thus, if the user of these known brushes does not need, thanks to the motorization, to implement a jerky gestures of brushing, he himself ensures the putting into contact of the brush with the teeth and the gums. However, during this contact and the displacement of the brush along the teeth and gums, the user may have, voluntarily or not, to excessively press the brush against the teeth or gums. However, an excessive contact pressure can lead to bruising the gums, to cause bleeding, a deterioration (erosion and weakening) of enamel or other trauma. Such excessive pressure is also likely to force the electric motor, with a risk of overheating and deterioration of the latter.

### DISCLOSURE OF THE INVENTION

The objects assigned to the invention therefore aim to remedy the drawbacks exposed in the above and to propose a new electric toothbrush which, while being compact and economical, makes it possible to reduce in a particularly reliable and effective way the risk that an excessive brushing pressure is exerted by the user.

Another object of the invention aims to propose a new electric toothbrush whose operation is based on a particularly simple and proven principle.

Another object of the invention aims to propose a new electric toothbrush whose operation is particularly intuitive.

Another object of the invention aims to propose a new electric toothbrush which promotes the adoption, by its user, of an optimal brushing routine.

Another object of the invention aims to propose a new electric toothbrush whose use is particularly simple and makes it possible to implement an optimal brushing in a particularly fast and easy way.

Another object of the invention aims to propose a new electric toothbrush which allows a particularly effective and gentle brushing, while optimally preserving the biological tissues.

Another object of the invention aims to propose a new electric toothbrush that implements simple and standard components.

Another object of the invention aims to propose a new particularly robust and light electric toothbrush.

The objects assigned to the invention are met using an electric toothbrush comprising an electric motor as well as a teeth brushing organ connected to said electric motor to be rotated by the latter, said electric toothbrush being characterized in that it comprises a measuring device of an electrical quantity representing a contact pressure between the brushing organ and the teeth, as well as a processing unit connected to said measurement device to emit a first warning signal when the value of said electrical quantity measured by said measurement device is higher than a predetermined threshold, said brushing organ comprising a brushing roller rotatably mounted according to a first rotation axis, said brushing roller comprising a central core substantially coaxial to said first rotation axis and brushing growths that radially protrude from the central core, said toothbrush including time-measuring means allowing to measure a first brushing duration during which the value of said electrical quantity measured by the measurement system is higher than said predetermined threshold, said first predetermined duration being used by said processing unit to calculate a brushing quality indicator.

### BRIEF DESCRIPTION OF THE DRAWINGS

Other particularities and advantages of the invention will appear in more detail in reading the detailed description which follows, in reference to the accompanying drawings, given as purely illustrative and non-limiting examples, in which:

FIG. 1 illustrates, according to a schematic view in elevation, an electric toothbrush in accordance with the invention, which communicates with a remote terminal, formed in this case by a mobile phone with touch screen, via a wireless radio waves connection of the Bluetooth® type.

FIG. 2 illustrates, in a perspective schematic view, a detail of the realization of the electric toothbrush in FIG. 1, which is part of a brushing head embedding the brushing organ of the teeth.

FIG. 3 is an enlarged view of a graphical interface displayed by the screen of the mobile phone in FIG. 1.

FIG. 4 schematically illustrates different zones of a graphic dentition representation implemented by the graphical interface of FIG. 3.

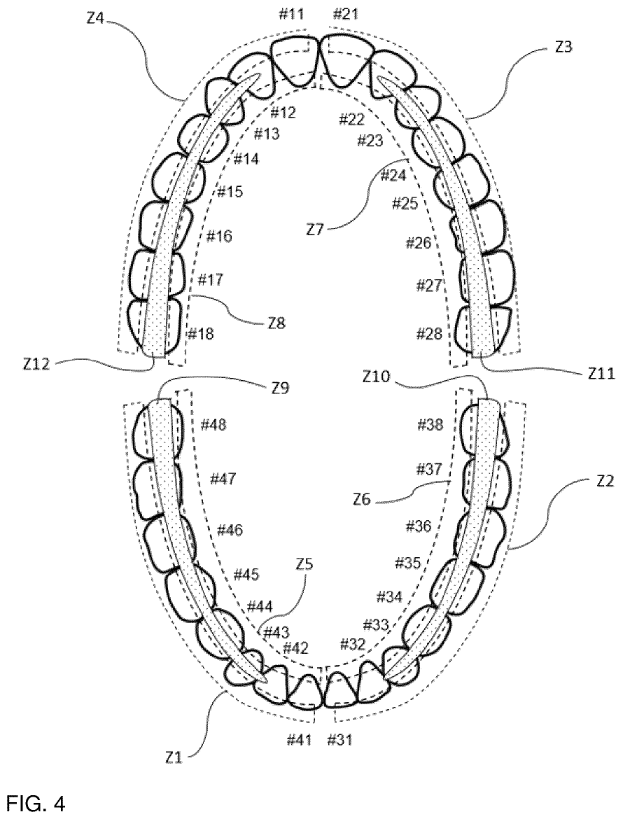

### BEST WAY TO IMPLEMENT THE INVENTION

The invention concerns an electric toothbrush 1, intended to maintain oral hygiene by elimination of food debris and dental plaque. The electric toothbrush 1 according to the invention is advantageously intended for humans, but, according to an alternative embodiment, it can be perfectly adapted to a veterinary use, for example for farming or company animals.

Advantageously, the electric toothbrush 1 comprises a gripping portion 2, which preferentially forms a handle, intended to be manually grasped by a user, to allow the latter to handle the electric toothbrush 1 and in particular to control its position and its orientation in space, as well as its pressure in contact with the teeth to brush. The handle which advantageously forms the gripping portion 2 extends for example longitudinally according to a central longitudinal axis X-X′. Preferably, the toothbrush 1 comprises a casing 2A which advantageously forms the gripping portion 2, and within which are intended to be housed different components, and in particular mechanical, electrical and electronic components of the electric toothbrush 1.

In accordance with the invention, the electric toothbrush 1 also comprises a brushing organ 3 of the teeth, which is advantageously arranged substantially at one end of the electric toothbrush 1. The latter thus presents for example a generally elongated shape which extends longitudinally according to said central longitudinal axis X-X′. Preferably, the brushing organ 3 is part of a brushing head 4 which is advantageously arranged in the axial extension of the gripping portion 2, as illustrated in figures. Preferably, the brushing head 4 is fixed in a removable way to the gripping portion 2. It is however alternately possible that the head 4 will be fixed permanently at the gripping organ 2, without the possibility of separation. The brushing organ 3 of the teeth is designed to be brought into contact with the teeth in order to ensure the cleaning, in this case by an abrasive mechanical brushing action. In order to ensure the brushing function assigned to it, the brushing organ 3 is provided with brushing growths 5, preferably formed by a plurality of hairs or pins. Said brushing growths 5 are preferably made of synthetic material, and advantageously present a substantially soft, flexible character.

In accordance with the invention, the electric toothbrush 1 comprises an electric motor (not visible to the figures), which is advantageously embedded by the gripping portion 2, and is for example housed in the aforementioned casing 2a which preferentially forms said gripping portion 2. The electric motor in question is preferably a continuous current motor, with a stator, a rotor and an output shaft secured to the rotor and rotatably driven by the latter. Said electric motor is advantageously intended to be powered by an electric power current, which is preferably a direct current. Said electric power current crosses the motor to put said stator and rotor into relative rotation. Advantageously, the electric power current in question is characterized by at least one physical parameter, for example the intensity. Advantageously, in order to provide said electric power current to the motor as well as eventually to other electric or electronic organs equipping the brush 1, the latter comprises an embedded energy source, formed for example by at least one cell or a battery, rechargeable or not, which is preferentially housed inside the gripping portion 2, for example within said casing 2A.

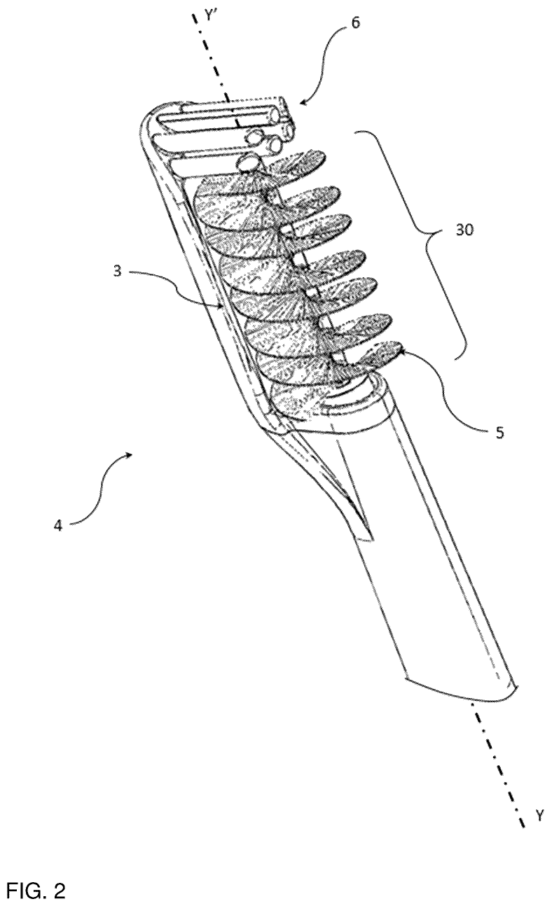

In accordance with the invention, the 3-teeth brushing organ is connected to said electric motor to be set in movement by the latter, and more precisely to be rotated by the latter. For example, the brushing organ 3 of the teeth is mechanically connected to the output shaft of said electric motor, directly or indirectly (for example through a mechanical reducer and/or a transmission device, including for example a cardan seal). The brushing organ 3 is thus designed to turn, preferably in a substantially continuous way, in the same direction, which direction can be modified according to the dentition zone to be brushed and the positioning of the electric toothbrush 1 relative to this zone. The use of a brushing organ which turns continuously in one direction of rotation or in another is preferred, because it allows a particularly effective cleaning of the dentition while limiting the traumatic risk. The implementation of an oscillo-rotative or vibrant brushing organ is less advantageous, in terms of compromise between brushing efficiency and the minimization of traumatic risk, than the use of a continuously rotary brushing organ, as in the preferred embodiment of the invention illustrated with figures. In this embodiment, the brushing organ 3 comprises a brushing roller 30 rotatably mounted according to a first rotation axis Y-Y′, which is advantageously parallel to, and preferably confused with, the aforementioned longitudinal central axis X-X′. The brushing roller 30 comprises, as illustrated with the figures, a central core, formed for example in this case by a substantially elongated core, substantially coaxial at said first rotation axis Y-Y′. Preferably, the central core extends in the continuity of the output shaft of the electric motor, which output shaft is also coaxial in the first rotation axis Y-Y′, which is advantageously confused with the longitudinal central axis X-X′. The brushing roller 30 further comprises the brushing growths 5, which are protruding from the radially central core, preferably over substantially the entire periphery of the latter, that is to say 360° around the central core. Preferably, the brushing growths 5, advantageously formed by substantially flexible pins or hairs, are distributed in a helical way, according to the first rotation axis Y-Y′. In other words, in this preferential embodiment, the brushing growths 5 each extend between an internal end connected to the central core and a free external end, so that they form a propeller, or a spiral, around said central core, along the latter, as illustrated by FIG. 2. For example, the central core is formed by a metallic wire folded in U which is twisted on itself to capture between the arms of U the brushing growths 5, so the twist in question imparted to the plurality of brushing growths 5 a propeller distribution. Thanks to this helical profusion, spiral around the first axis of rotation Y-Y′, the brushing roll 30 is particularly effective from the point of view of the cleaning action, while being able to provide a mild brushing that respects the sensitivity of the concerned tissues.

Preferably, and as illustrated in the figures, the brushing head 4 is also provided, at its free end, in front of the brushing roller 30, a plurality of pins 6 which form a flexible trim arranged vis-a-vis the distal end of the brushing organ 3, in the axial extension of the latter and substantially transversely to the first rotation axis Y-Y′. The flexible trim formed by pins 6 in question provides a coverage of the brushing organ 3 at the level of an apparently non-functional zone of the latter, making it possible to avoid any interference of the non-functional zone in question with the mucous membranes, while presenting a flexible character, and therefore respectful of tissues and providing comfortable brushing. Advantageously, the pins 6 forming this flexible trim can also be used for the brushing.

In accordance with the invention, the electric toothbrush 1 comprises a device for measuring an electrical quantity representative of a contact pressure between the brushing organ (3) and the teeth (and/or the gums). The measurement device in question advantageously forms a sensor capable of providing as output a variable signal representative of the pressure (or the support force) exerted by the brushing roller 30 on the teeth. Said electrical quantity measurement device is advantageously housed in the casing 2, that is to say it is preferably embedded by the gripping portion 2, and is advantageously powered by the above-mentioned embedded energy source.

The electric toothbrush 1 also comprises a processing unit (not visible in figures) which is also advantageously housed in the casing 2A, that is to say it is advantageously embedded by the gripping organ 2. The processing unit comprises electronic processing means, including for example an electronic card which advantageously includes a microcontroller or a programmable logical network (for example a user-programmable gate array, usually designated by FPGA). The processing unit is connected to the device for measuring said electrical quantity to emit a first warning signal when the value of said electrical quantity measured by the measurement device is greater than a predetermined threshold.

Preferably, said electrical quantity is consisting of a physical parameter that characterizes the power current of the electric motor. In this case, the electric power current in question is characterized by at least said electrical quantity. In this case, the latter constitutes in other words a physical parameter which characterizes the electric power current. In this preferential embodiment, said measurement device is a device for measuring said electrical quantity characteristic of the electric power current. The measurement device in question advantageously forms in this case a sensor capable of providing as output a variable signal representative of the value of said electrical quantity. The invention is thus based, in this preferential embodiment, on an extremely reliable and robust principle, according to which the electric power current consumed by the electric motor varies according to the resistant torque applied to said electric motor, and more precisely to the output shaft of the latter. The resistant torque in question itself depends in this case on the contact pressure between the brushing organ 3 and the tissues (gums and/or teeth) against which the brushing organ 3 is pressed by the user. Indeed, the more the contact pressure increases, the more the friction between the moving brushing organ 3 and the tissues, and the more the resistant torque exerted on the output shaft of the motor to which the brushing organ is connected 3 is important. Consequently, by measuring a characteristic parameter of the electric current supplying the electric motor, it is possible to indirectly access a quantity representative of the contact pressure between the brushing organ 3 and the tissues (teeth and/or gums).

Preferably, said electrical quantity is the intensity of said electric power current. In this preferential embodiment, said measurement device is thus designed to detect an exceeding, by the electric power current crossing the electric motor, of the predetermined threshold. In this case, said measurement device advantageously includes an ammeter or an adapted amperometric sensor. Said predetermined threshold corresponds in this case for example to an intensity value reflecting a level of contact pressure of the brushing organ 3 on the tissues beyond which there is a risk of deterioration or weakening of the gums and/or teeth. The invention is of course not limited to the embodiment according to which the measured electrical quantity is the intensity of the electric power current. For example, it is perfectly possible that said electrical quantity is the electrical power consumed by said electric motor, or any other appropriate quantitative physical parameter.

It is also possible, without departing from the scope of the invention, that the electrical quantity is not consisting of a physical parameter that characterizes the electric power current. For example, said electrical quantity can alternately correspond to an electrical signal emitted by a flexion sensor which detects a flexion of the output shaft of the motor and/or the central core, without departing from the scope of the invention.

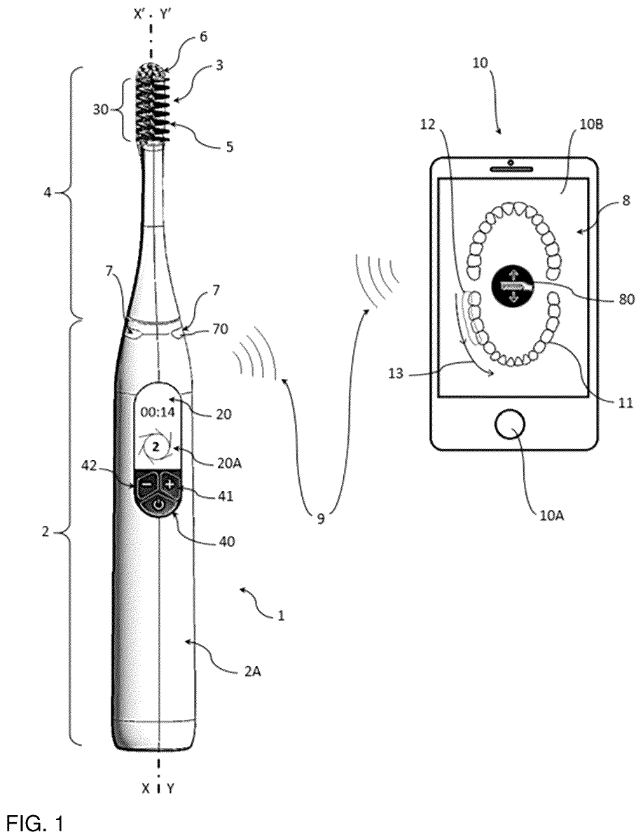

Advantageously, said processing unit is intended to be connected to at least one first signaling organ 7 so that the emission of said first warning signal by said processing unit, in response to the detection of an electrical quantity value which exceeds the predetermined threshold, commands the emission of a first visual 70 and/or sound signal by said first signaling organ 7. Said first visual 70 and/or sound signal thus makes it possible to warn the user that the pressure exerted on his teeth and/or gums by means of the electric toothbrush 1 that he is manipulating is excessive, thereby encouraging him to reduce the contact pressure in question. For example, the first signaling organ 7 comprises a light indicator, which is the occurrence in the shape of a strip and extends on the surface of the casing 2A according to a profile which can be in the shape of a horseshoe, as illustrated by FIG. 1. The light indicator in question is for example designed to light up with a first color (for example the blue color) as long as the value of said measured electrical quantity is less than or equal to said predetermined threshold, then to light up according to a second color (for example the red color), different from said first color, in response to the emission of said first warning signal, as long as the value of said measured electrical quantity is greater than said predetermined threshold.

Advantageously, said processing unit is intended to be connected, in addition or instead, from the first signaling organ 7, to a second signaling organ 8 which is preferentially deported, that is to say it is not embedded by the casing 2A itself (as is the case of the light indicator mentioned above) but is distinct and independent of said electric toothbrush 1. For example, the electric toothbrush 1 includes a data exchange module designed to communicate by radio waves 9 with a terminal 10 which is preferentially remote, distinct and independent of the electric toothbrush 1. Said data exchange module is advantageously embedded in the casing 2A, for example inside the handle forming the gripping portion 2. Said processing unit is advantageously connected to said data exchange module. The terminal 10 is advantageously provided with an additional data exchange module designed to be paired with said data exchange module equipping the electric toothbrush 1, in order to establish said communication by radio waves 9, which is therefore a wireless communication. Said wireless communication is advantageously a Bluetooth® connection, which is preferentially based on the protocol designated by the brand registered «Bluetooth Low Energy», also designated by the acronym «BLE» or by the name «Bluetooth Smart ®». This means that in this preferential case, both the electric toothbrush 1 and the terminal 10 have respective combined telecommunication means, based on Bluetooth® technology, to carry out contactless communication or wired connection between the electric toothbrush 1 and the terminal 10. Of course, the invention is not limited to the implementation of a Bluetooth® connection and other types of radio communications can be implemented (for example of the Wi-Fi type) without departing from the scope of the invention.

Advantageously, the communication by radio waves 9 between the electric toothbrush 1 and the terminal 10 allows a bidirectional transfer of digital or analog data between the electric toothbrush 1 and the terminal 10. The latter is for example formed by a computer terminal, such as a mobile phone (smartphone) or a touch pad for example. The terminal 10 in question is preferentially provided with a command interface 10A, which includes for example one or more buttons, and a display screen 10B, which is preferably a touch screen, in which case said display screen 10B is part of the command interface 10A.

Advantageously, the display screen 10B forms said second signaling organ 8 mentioned above. In this case, the processing unit is connected, via the connection by radio waves 9, to said second signaling organ 8 formed by the display screen 10B of the terminal 10, so that the emission of said first warning signal by the processing unit commands the emission of a second visual 80 and/or sound signal by said second signaling organ 8 formed in this case by the terminal 10. In the embodiment illustrated in figures, the processing unit controls the display, by the display screen 10B of the terminal 10, of a pictogram forming said second visual signal 80, which appears for example substantially in the center of the screen when the value of the measured electrical quantity is greater than said predetermined threshold, and as long as said value exceeds said predetermined threshold.

In the embodiment illustrated in figures, the processing unit is connected to both the first signaling organ 7 and to the second signaling organ 8, to implement a redundant signaling, with a first local visual signal 70, arranged on the electric toothbrush 1 itself, for example on the surface of the casing 2A, and a second visual signal 80 deported to the terminal 10. It is however perfectly possible to implement only the first signaling organ 7 or only the second signaling organ 8.

Advantageously, the processing unit is at least partly formed by the terminal 10, that is to say by electronic means and software embedded by the latter. For example, it is possible that the electric toothbrush 1 embeds, preferably within the casing 2A, electronic means making it possible to emit the first warning signal and command the emission of the first visual signal 70. It is also possible that the electric toothbrush 1 comprises only means allowing to collect a signal representative of the value of said electrical quantity measured by said measurement device and to communicate this signal, for example in real time, to the terminal 10. In this case, the terminal 10 includes processing means, which forms all or part of the processing unit, and which are designed to determine whether the value of the measured electrical quantity is greater than the predetermined threshold and to emit, if that is the case, said first warning signal which commands the display of a visual signal, whether it is a visual signal located on the terminal 10 (second visual signal 80) or a visual signal located on the casing 2A of the electric toothbrush 1 (first visual signal 70).

The processing unit is configured to calculate a brushing quality indicator which takes into account any exceeding of said predetermined threshold by said electrical quantity. In other words, the brushing quality indicator, which is preferentially intended to be displayed by the display screen 10B of the terminal 10 (and/or by a screen 20, with which the gripping organ 2 is possibly provided), takes into account the occurrence of one or more exceeding(s) of the predetermined threshold to qualify the quality of the brushing. Said brushing quality indicator is presented for example in the form of a score (expressed by a number or letter), and/or by a graphic element whose geometry and/or color varies as a function of the obtained brushing quality level.

Advantageously, said electric toothbrush 1 includes time-measuring means, which are preferably controlled by said processing unit, to determine a first brushing duration D1i during which the value of said electrical quantity measured by the measurement device is greater than said predetermined threshold, and which corresponds for example to the duration during which said first warning signal is emitted. In other words, the time-measuring means make it possible to measure the time D1i during which, during a brushing session using the electric toothbrush 1, the value of said measured electrical quantity by the measurement device is greater than a predetermined threshold, thus characterizing the application of excessive contact pressure. Said first predetermined duration D1i can then be used by the processing unit to calculate said brushing quality indicator. Advantageously, the time-measuring means are also designed to determine, preferably under the control of said processing unit, a brushing time Ti during which the electric toothbrush 1 is used to brush the dentition of a user, or a predetermined zone Zi of said dentition. For example, the quality of the aforementioned brushing quality takes into account an effective brushing time TEi of a dentition zone Zi which is calculated as follows: TEi=Ti−D1i, where Ti represents the brushing time of the concerned dentition zone Zi carried out by means of the toothbrush 1, and where D1i represents the first above-mentioned predetermined duration, during which the value of the electrical quantity measured by the measurement device exceeds the predetermined threshold. The brushing quality indicator mentioned above is then preferentially a function score at least of the effective brushing time TEi of the zone Zi.

Alternatively, or in addition to the technical measures mentioned in the above, said time-measuring means form timing means, which are controlled by said processing unit to dedicate a predetermined brushing time TDi of the dentition or of a predetermined zone Zi of the latter. The predetermined time TDi in question, which is deducted by the timing means, corresponds to a time considered as allowing to obtain an optimal brushing result. Preferably, the timing means in question are designed to interrupt said count of said predetermined brushing time TDi when said first warning signal is emitted. Thus, the count of said predetermined brushing time TDi advantageously takes into account the time periods of duration D1i advantageously during which the value of the electrical quantity measured by the measurement device exceeds the predetermined threshold, to exclude these ranges of duration D1i from said count. Advantageously, the electric toothbrush 1 comprises a movement sensor, which is preferably housed inside the electric toothbrush 1, for example within the casing 2A. Said movement sensor includes, for example, an accelerometer and/or a 3D accelerometer and/or a gyrometer and/or an inertia unit, in order to advantageously allow the detection of the toothbrush in the space, and in particular its positioning and its orientation in relation to the user dentition. Said processing unit is advantageously connected to said movement sensor to detect an inappropriate movement of the toothbrush 1 and emit a second warning signal when such an inappropriate movement is detected. Advantageously, the nature of the inappropriate movements detected by the movement sensor under the control of the processing unit varies depending on the dentition zone Zi, which is being brushed, which zone Zi can be detected automatically from positioning data coming from the movement sensor.

Advantageously, the first signaling organ 7 and/or the second signaling organ 8 is (are) connected to the processing unit so that the emission of said second warning signal commands the emission of a third visual and/or sound signal by said first signaling organ 7 or a fourth visual and/or sound signal by said second signaling organ 8. In this way, the user can be informed in real time because he is performing inappropriate movements with its electric toothbrush 1, especially with regard to the dentition zone Zi which he is brushing, which encourages him to modify his gestures.

Preferably, said brushing quality indicator calculated by the processing unit takes into account the possible detection of inappropriate movements.

Preferably, said time-measuring means are also designed to determine a second brushing duration D2i during which an inappropriate movement of said toothbrush is detected. More specifically, the time-measuring means are preferentially controlled by said processing unit to determine said second brushing duration D2i during which said second warning signal is emitted. In other words, the time-measuring means make it possible to measure the time D2i during which, during a brushing session using the electric toothbrush 1, the movement sensor detects an inappropriate movement. Said second predetermined duration D2i can then be used by the processing unit to calculate said brushing quality indicator. Advantageously, the aforementioned effective brushing time TEi of the dentition zone Zi takes into account said second predetermined duration and is for example automatically calculated by the processing unit as follows: TEi=Ti−(D1i+D2i) where Ti represents the brushing time of the concerned dentation zone Zi carried by means of the toothbrush 1, where D1i represents the above predetermined first duration and where D2i designates said second aforementioned predetermined duration during which an inappropriate movement of the brush 1 is detected. The brushing quality score mentioned above is then preferentially function of at least the effective brushing time TEi of the zone Zi thus calculated to take into account not only periods during which an excessive contact pressure is exerted but also periods during which the brush 1 performs inappropriate movements.

Preferably, the aforementioned timing means are designed to interrupt said count of said predetermined brushing time TDi when said second warning signal is emitted. Thus, the count of said predetermined brushing time TDi advantageously takes into account not only time periods of duration D1i during which the value of the electrical quantity measured by the measurement device exceeds the predetermined threshold, to exclude these ranges of duration D1i from said count, but also time periods of duration D2i during which an inappropriate movement is detected, to also exclude these ranges of duration D2i from said count.

Advantageously, said electric motor is connected to the processing unit so that the rotation direction of said brushing roller 30 is automatically modified according to position signals produced by said movement sensor. In other words, the processing unit determines, from the position signals emitted by the movement sensor, the zone Zi of the dentition which is under brushing and controls in response the electric motor so that the output shaft rotatably drives the brushing roller 30 according to a direction which allows a brushing of the gum to the upper part of the teeth (brushing called «red to white» generally recommended by the health authorities).

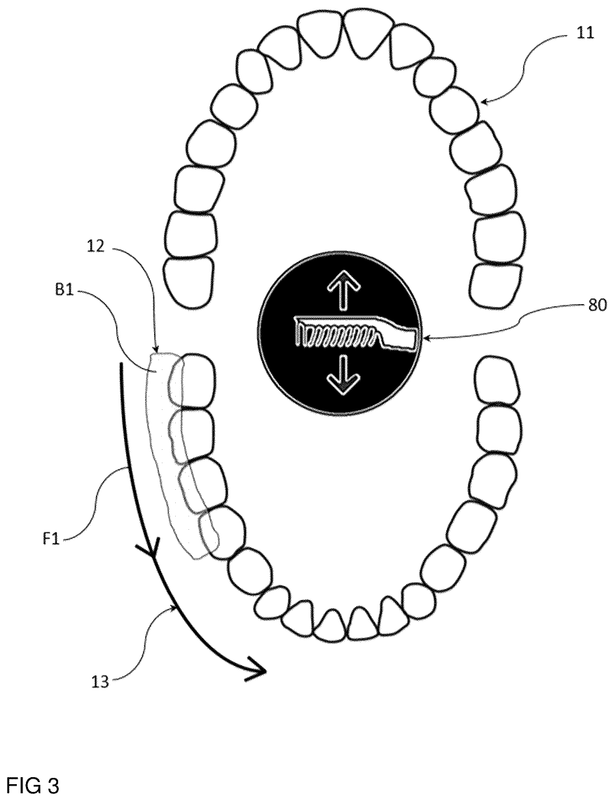

Advantageously, said processing unit is designed to display on said display screen 10B of the terminal 10 both a representation 11 (preferably static) of the dentition of a user and a representation 12, preferably dynamic, in real time, a brushing progression of said dentition carried out using the toothbrush 1, said dynamic representation 12 being generated from position signals produced by said movement sensor. Said static representation 11 of the dentation includes, for example, a stylized representation of the teeth of the mandible and the teeth of the maxilla, each represented flat in top view (that is to say in overhanging of the masticatory faces), with the teeth of the maxillary arranged above the teeth of the mandible. Said dynamic representation 12 of the brushing progression is presented for example in the form of a colored highlight line Bi which progresses by being elongated along the concerned zone Zi of the dentition represented on the display screen 10B, as visible in FIGS. 1 and 3 for example.

Advantageously, the processing unit is designed to freeze the dynamic representation 12 of the brushing progression when the first warning signal is emitted. This means that as soon as an excessive contact pressure is detected, which corresponds to an exceeding of the predetermined threshold by said value of the measured electrical quantity, the geometry of the graphic object which represents the brushing progression is freeze, even if the user continues to displace the electric toothbrush 1 along the dentition. This allows the user to intuitively understand that the brushing he is carrying out is not taken into account as an appropriate brushing. The user understanding is facilitated by the displaying of a warning pictogram forming the second visual signal 80.

Advantageously, said static representation 11 of the dentition includes several dentition zones, for example (the numbering of the teeth indicated below corresponds to the teeth designation code of the ISO 3950:2016—the teeth numbers are preceded by the sign # in order to distinguish digital references used in the drawings):
a first zone Z1 corresponding to the external faces of the teeth #41 to #48;
a second zone Z2 corresponding to the external faces of the teeth #31 to #38;
a third zone Z3 corresponding to the external faces of the teeth #21 to #28;
a fourth zone Z4 corresponding to the external faces of the teeth #11 to #18;
a fifth zone Z5 corresponding to the internal faces of the teeth #41 to #48;
a sixth zone Z6 corresponding to the internal faces of the teeth #31 to #38;
a seventh zone Z7 corresponding to the internal faces of the teeth #21 to #28;
an eighth zone Z8 corresponding to the internal faces of the teeth #11 to #18;
a ninth zone Z9 corresponding to the masticatory faces of the teeth #44 to #48;
a tenth zone Z10 corresponding to the masticatory faces of the teeth #34 to #38;
an eleventh zone Z11 corresponding to the masticatory faces of the teeth #24 to #28; and
a twelfth zone Z12 corresponding to the masticatory faces of the teeth #14 to #18.

This cartography is advantageously recorded in a memory of the processing unit. Said processing unit is preferentially designed to display, on said display screen 10B, preferably in superposition to the static representation 11 of the dentition, indications 13 inviting the user to brush a respective one of said dentition zones Zi during a respective predetermined time TDi, with i=1 to 12. For example, as successive indications, the processing unit can display a dynamic arrow Fi which is displayed along or on the concerned dentition zone Zi during said predetermined time TDi corresponding to said concerned zone, with i=1 to 12. FIGS. 1 and 3 thus illustrate the arrow F1 inviting the user to brush the zone Z1. For example, the predetermined time TDi during which the arrow Fi is displayed inviting the user to brush the dentition zone Zi is predetermined as follows:
TDi=6 s for the zones Zi with i=1 to 8 (internal and external faces); and
TDi=3 s for the zones Zi with i=9 to 12 (masticatory faces).

The dynamic representation 12 of the brushing progression is advantageously designed to illustrate, for example by a graphic evolution, the time actually passed through the brushing roller 30 in the concerned zone Zi, this progression ceasing (as well as the graphic evolution that illustrates this) when the brushing roller 30 has brushed the teeth in the zone Zi in question during the corresponding predetermined duration (for example equal to 6 seconds for the external or internal faces of a quadrant).

Preferably, for each dentition zone Zi, the processing unit is designed to display on the screen 10B, near said concerned zone Zi, an indication Fi during the predetermined time TDi whose count preferentially takes account of the first brushing duration D1i during which the value of the electrical quantity measured by the measurement device is greater than the predetermined threshold and/or the second brushing duration D2i during which an inappropriate movement of the toothbrush 1 is detected via of the movement sensor, with i=1 to 12.

In the example of FIG. 3, the processing unit displays on the display screen 10B an indication F1 inviting the user to brush the external face of the teeth #48 to #41 (zone Z1) during the predetermined time TD1 (equal for example to 6 s), and the brushing progression, corresponding to the displacement of the toothbrush 1 along the external faces of the teeth #48 to #41, is materialized on the screen 10B by a highlight line B1 which is superimposed, at the level of the external faces of the concerned teeth, on the static representation 11 of the dentition displayed by the display screen 10B.

An example of using an electric toothbrush 1 in accordance with the embodiment illustrated in the figures will now be described in detail.

First, the user switches the toothbrush on by pressing an on/off button 40 disposed on the casing 2A, for example below the screen 20. The toothbrush 1 is then under tension, with its data exchange module ready to be paired with a conjugated module embedded by the terminal 10 (which is formed in this case by a smart mobile phone with touch screen). At the same time, as soon as the toothbrush 1 is under tension, the brushing roller 30 turns continuously according to the first rotation axis Y-Y′ (which is in this case confused with the central longitudinal axis X-X′) in a first rotation direction, at a speed which is preferably substantially constant and which corresponds to a setting identified by a pictogram 20A which is displayed on the screen 20. In this case, said pictogram 20A represents in a stylized way the brushing roller 30 seen from the front, with a number in its center designating a rotation speed adjustment. At the same time, as soon as the toothbrush is switched on 1, the screen 20 embedded on the handle of the latter also displays the time, measured by the time-measuring means, which has been passing since the switching on of the brush 1 by pressing on the switch 40.

The user then launched a dedicated application which is executed by the terminal 10. This application commands an automatic pairing of the data exchange module embedded by the toothbrush 1 with the conjugated module embedded by the terminal 10, so as to establish a wireless data transfer bidirectional connection, for example a radio waves connection of the Bluetooth® type, between the toothbrush and the terminal 10.

The application carried out by the terminal 10 displays on the touch screen 10B of the terminal 10 a menu allowing access to different interfaces. The menu in question thus allows for example to select a configuration interface which allows the user to choose a brushing speed program according to the condition of his own gums. The interface displayed on the screen 10B by the application carried out by the terminal 10 allows for example the user to choose from 3 brushing programs, namely:
a «periodontal» program allowing a choice among 3 possible rotation speeds V1, V2, V3, which is adapted to the inflammatory gums presenting for example signs of gingivitis or periodontitis and the gums during the post-operative period, with:
V1=2 turns/second±0.5 turns/second;
V2=3 turns/second±0.5 turns/second;
V3=4 turns/second±0.5 turns/second.
a «comfort» program allowing a choice among 3 possible rotation speeds V4, V5, V6, which is adapted to the healthy and fine gums:
V4=6 turns/second±0.5 turns/second;
V5=7 turns/second±0.5 turns/second;
V6=8 turns/second±0.5 turns/second.
a «fast» program allowing a choice among two possible rotation speeds V7, V8, which is suitable for healthy and thick gums:
V7=10 turns/second±0.5 turns/second;
V8=12 turns/second±0.5 turns/second.

Advantageously, the interface displayed on the screen 10B of the terminal 10 contains a questionnaire which allows the user, by indicating the state of his own gum (healthy gum, inflammatory gum, gum in post-operative period, fine gum, thick gum, etc.) to determine the adapted program among the 3 aforementioned programs. Then, the interface allows the user to select, for the selected program, the rotation speed of the brushing roller 30, by means for example of command buttons 41, 42 arranged on the handle (or via the command interface displayed by the screen 10B). For example, if the user has selected the «periodontal» program, he can then choose to give the brushing roller 30 either speed V1, or speed V2, or speed V3. In the same way, if it is the «comfort» program which was selected by the user, then the latter can select, via the interface displayed by the terminal 10 and/or the buttons 41, 42, a rotation speed of the brushing roller 30 among the V4, V5 or V6 speeds. If it is the «fast» program that is selected, then the user will have the choice between two constant rotation speeds of the brushing roller 30, namely either the speed V7 or the speed V8. The choice of the brushing speed is transmitted, by the radio connection, to the portion of the processing unit which is embedded by the electric toothbrush 1. The processing unit commands the electric motor to impart on the brushing roller 30 a rotation according to a constant speed which corresponds to that selected by the user.

The aforementioned menu also makes it possible to display a support interface to the brushing and control of the latter, said interface corresponding to that visible in FIGS. 1 and 3.

Firstly, a dynamic arrow F1 encourages the user to brush the external faces of the teeth #48 to #41 (zone Z1). The user then positions the brushing roller 30 against the external face of the tooth #48 as invited by the dynamic arrow F1, then displaces the brush 1 along the external faces of the teeth #48 to #41 to brush each of them, until reaching the tooth #41, as invited by the dynamic arrow F1 which is displayed on the screen 10B. During this brushing sequence of the zone Z1, the brushing roller 30 runs according to a constant speed (whose value corresponds to that selected beforehand by the user as set out above) according to a direction which is controlled by the processing unit according to data from the movement sensor. The processing unit, thanks to said data coming from the movement sensor, imparted to the brushing roller 30 a direction of rotation which allows a brushing from the gums to the teeth (i.e. «from red to white»). The dynamic arrow F1 encourages the user to brush the zone Z1 for a predetermined period, which is preferably equal to substantially 6 seconds. The brushing progression is materialized on the screen 10B by a highlight line B1 which progresses along the external faces of the teeth #48 to #41 in response to the real displacement of the electric toothbrush 1 detected by the movement sensor. The progression of the highlight line B1 is thus controlled by the position data coming from the movement sensor.

If, during the brushing the external faces of the teeth #48 to #41 of the zone Z1, the user exerts too much pressure with the brushing roller 30 on the teeth and/or the gums, the intensity of the electric power current of the motor increases and exceeds the predetermined threshold, which generates the display, through the screen 10B, of a warning pictogram 80 encouraging the user to reduce the contact pressure. The pictogram 80 remains displayed on the screen 10B, for example in the center of the latter, as long as the contact pressure has not been reduced by the user. Likewise, the light indicator 70 produces a red light signal as long as the contact pressure has not been reduced so that the intensity of the electric power current finds a value below the predetermined threshold.

The same mechanism is applied when the user operates an inappropriate movement with the toothbrush 1 while he brushes the external faces of the teeth #48 to #41 of the zone Z1. Such an inappropriate movement can consist for example in a jerky movement of the electric toothbrush 1, or simply in a distance from the electric toothbrush 1 out of the brushing zone (for example if the brushing roller 30 is out of the user's mouth). When such an inappropriate movement is detected, by means of the movement sensor under the control of the processing unit, a specific pictogram (not illustrated) is displayed on the screen 10B and the light indicator 70 lights again with a red light. Furthermore, as long as the first warning signal or the second warning signal is emitted, the highlight line B1 corresponding to the dynamic representation 12 in real time of the brushing progression freezes, that is to say its length no longer evolves and that it ceases to extend towards the extremal tooth #41.

Once the zone 1 brushed for an effective time TE1 of 6 seconds (after deduction of the first and second durations D11, D21 during which the first signal or the second signal is emitted), the arrow F1 disappears and a new dynamic arrow F2 (no illustrated) is displayed on the screen 10B near the second zone Z2 to encourage the user to brush the zone Z2 of the tooth #31 to the tooth #38, on the external faces of the latter. The processing unit takes into account the data coming from the movement sensor to automatically change the direction of rotation of the brushing roller 30, so that when brushing the zone Z2, the direction of rotation is adapted to the orientation of the toothbrush 1, so that the brushing roller 30 performs a brushing from the gums to the teeth. The brushing time of the zone Z2 is again 6 seconds.

The user is then successively invited, by dynamic arrows Fi (where i corresponds to the concerned zone number Zi) appearing one after the other on the screen 10B in an appropriate position, to be brushed successively:
the internal faces of the teeth #38 to #31 of the zone Z6 (for example for 6 s),
the internal faces of the teeth #41 to #48 of the zone Z5 (for example for 6 s),
the masticatory faces of the teeth #48 to #44 of the zone Z9 (for example for 3 seconds),
the masticatory faces of the teeth #34 to #38 of the zone Z10 (for example for 3 seconds),
the external faces of the teeth #18 to #11 of the zone Z4 (for example for 6 seconds),
the external faces of the teeth #21 to #28 of the zone Z3 (for example for 6 seconds),
the internal faces of the teeth #28 to #21 of the zone Z7 (for example for 6 seconds),
the internal faces of the teeth #11 to #18 of the zone Z8 (for example for 6 seconds),
the masticatory faces of the teeth #18 to #14 of the zone Z12 (for example for 3 seconds) and
the masticatory faces of the teeth #28 to #24 in the zone Z11 (for example for 3 seconds).

Of course, for each zone Zi the operation is the same as for the zone Z1 described in detail in the above, in particular with regard to the progression of the dynamic representation 12 of the brushing progression on the concerned zone and taking account of excessive contact pressures and/or inappropriate movements.

Advantageously, it is possible that the user goes from a zone Zn to another zone Zm without having been invited to it by the interface displayed on the screen 10B, and even if the brushing of the zone Zn was not completely finished (for example because the user has carried out inappropriate movements or implemented excessive contact pressure). In this case, once the brushing sequence has been completed, that is to say once all the zones Z1 to Z12 have been brushed, the zones Zn where the brushing has been incomplete (due for example to a too short effective brushing time, possibly due to inappropriate movements and/or excessive contact pressure) are indicated by the interface displayed by the screen 10B, so as to invite the user to re-brush the concerned zones Zn to obtain an optimal brushing. If the user does not respond to this invitation, the brushing cycle is closed.

Once the brushing cycle has been closed, the application displays on the screen 10B a brushing score S that corresponds to said brushing quality indicator that the user has just made by means of the electric toothbrush 1.

The brushing score S in question is for example calculated as set out in the following:
When each zone Zi, with i=1 to 8, has been brushed during the corresponding predetermined time (which is for example equal to 6 seconds for the zones Z1 to Z8), then 1 point is allocated, a total of 8 possible points if the 8 external and internal zones Z1 to Z8 were all brushed properly during each at least 6 seconds.
For each zone Zi, with i=9 to 12, brushed during the corresponding predetermined time (which is for example equal to 3 seconds), half a point (0.5 point) is assigned, a total of 2 possible points if the 4 masticatory zones Z9 to Z12 have each been brushed properly during the corresponding predetermined time of 3 seconds.

Consequently, if the brushing cycle is done correctly completely, then the brushing time is a total of a minute (6×4+6×4+4×3) and corresponds to a maximum total score of 10 points, which indicates a satisfactory quality of brushing.

In the event that during the brushing of one of the zones Z1 to Z12 a bad gestures (too high contact pressure leading to the emission of the first signal or inappropriate movement leading to the emission of the second signal) is detected, then not only does the dynamic representation 12 of the brushing progression freeze, but the calculation of the number of points associated with the concerned zone Zi is carried out by first calculating the effective time TEi of the concerned zone Zi in the following way, by means of the processing unit: TEi=Ti−(D1i+D2i), with i=1 to 12, or TEi is the effective brushing time of the zone Zi, Ti is the total brushing time of the zone Zi, that is to say the time during which the brushing roller 30 was positioned in or towards the concerned zone Zi, D1i is the first duration during which the first signal was emitted during the brushing of the zone Zi in question and D2i is the second duration during which the second signal was emitted during the brushing of the zone Zi in question.

Then, the processing unit compares for the concerned zone Zi of the dentition the effective time TEi calculated according to the above method with the corresponding predetermined time, with for example TDi=6 s when i=1 to 8 and TDi=3 s for i=9 to 12.

If TEi/TDi>K, with K≥80% and preferably K≥90%, then the processing unit affects 1 point to the brushing of the concerned zone Zi. If on the contrary TEi/TDi≤K, then the processing unit assigns 0 point to the brushing of the concerned zone Zi.

Of course, thanks to the fact that the dynamic representation 12 freezes, and also thanks to the display of a perceptible warning by the user (for example the first visual signal 70), the user can immediately correct his brushing gestures to make sure to satisfy the TEi/TDi>k condition. In this case, the brushing error is fixed immediately and the dynamic representation 12 of the brushing progression resumes its geometric evolution and continues for example until its end.

Otherwise, where the user does not go back and one of the zones Zi was badly brushed, so that the maximum possible number of points has not been reached, then, when the final score S is displayed (therefore with in the latter case S<10), a graphic signaling of the zones Zi where the maximum possible score has not been reached is displayed (with for example a red-colored highlight) to invite the user to start brushing again in the concerned zones to increase their score. In this case, the processing unit is designed to also advantageously indicate the order to pass the electric brush 1 on the concerned zones, if there are several.

Finally, the processing unit is advantageously designed to take into account the fact that for some users, there may be a doubt as to whether the first dynamic arrow F1 designates the lower right district or the lower left district of the dentition. The algorithm implemented by the processing unit makes it possible to get rid of this difficulty by automatically recalculating, if the user does not start as indicated by the zone Z1 but rather by the zone Z2, the brushing sequence that follows, with the appropriate order of the zones to be brushed. The user can therefore start from the zone Z1 or from the zone Z2. Depending on whether the electric toothbrush 1 detects, thanks to the movement sensor under the control of the processing unit, that the first brushed zone is the zone Z1 or the zone Z2, then the following brushing sequence is suitable accordingly automatically, so as to propose a path of the brush 1 which goes around all the teeth (internal and external faces) including the masticatory zones.

In the case that the user begins the brushing cycle with the zone Z2, the user is guided by the application to carry out the following brushing sequence:
External faces of the teeth #38 to #31 of the zone Z2 (for example for 6 s),
External faces of the teeth #41 to #48 of the zone Z1 (for example for 6 s),
Internal faces of the teeth #48 to #41 of the zone Z5 (for example for 6 s),
Internal faces of the teeth #31 to #38 of the zone Z6 (for example for 6 s),
Masticatory faces of the teeth #38 to #34 of the zone Z10 (for example for 3 seconds),
Masticatory faces of the teeth #48 to #44 of the zone Z9 (for example for 3 seconds),
External faces of the teeth #28 to #21 of the zone Z3 (for example for 6 seconds),
External faces of the teeth #11 to #18 of the zone Z4 (for example for 6 seconds),
Internal faces of the teeth #18 to #11 of the zone Z8 (for example for 6 seconds),
Internal faces of the teeth #21 to #28 of the zone Z7 (for example for 6 seconds),
Masticatory faces of the teeth #28 to #24 of the zone Z11 (for example for 3 seconds) and
Masticatory faces of the teeth #18 to #14 of the zone Z12 (for example for 3 seconds).

Advantageously, the display on the screen 10B of the teeth and the path of the brush 1 (materialized by the dynamic graphic representation 12) is carried out in a reversal way, that is to say in «mirror» mode, as illustrated in figures. This facilitates the user's gestures which follows the same direction as the arrows Fi displayed on the screen 10B.

The invention ultimately allows, in particular in its preferential embodiment illustrated and exposed in detail in the above, to carry out in an intuitive and rapid manner, an optimal brushing of the teeth in a reduced time, with a particularly simple, light and compact construction brush.

### INDUSTRIAL APPLICABILITY

The invention finds its industrial application in the design, manufacture and use of electric toothbrushes.

1. An electric toothbrush (1) comprising an electric motor as well as a brushing organ (3) of the teeth connected to said electric motor to be rotated by the latter, said electric toothbrush (1) being characterized in this that it comprises a device for measuring an electrical quantity representative of a contact pressure between the brushing organ (3) and the teeth, as well as a processing unit connected to said measurement device to emit a first warning signal when the value of said electric magnitude measured by said measurement device is greater than a predetermined threshold, said brushing organ (3) comprising a brushing roller (30) mounted on rotation according to a first rotation axis (Y-Y′), said brushing roller (30) comprising a central core substantially coaxial to the first axis of rotation (Y-Y′) and brushing growths (5) that radially protrude from said central core, said toothbrush (1) including time-measuring means allowing to measure a first brushing duration (D1i) during which the value of said electrical quantity measured by the measurement device is greater than said predetermined threshold, said first predetermined duration (D1i) being used by said processing unit to calculate a brushing quality indicator.

2. The electric toothbrush (1) according to claim 1 characterized in that said electric motor is powered by an electric power current, said electrical quantity being consisting of a physical parameter that characterizes said electric power current.

3. The electric toothbrush (1) according to claim 2 characterized in that said electrical quantity is the intensity of said electric power current.

4. The electric toothbrush (1) according to claim 1 characterized in that said processing unit is intended to be connected to at least one first signaling organ (7) so that the emission of said first warning signal by said processing unit commands the emission of a first visual (70) and/or sound signal by said signaling organ (7).

5. The electric toothbrush (1) according to claim 1 characterized in that it comprises a movement sensor, which includes an accelerometer and/or a gyrometer and/or an inertia unit, said processing unit being connected to said movement sensor to detect an inappropriate movement of said toothbrush (1) and emit a second warning signal when such an inappropriate movement is detected.

6. The electric toothbrush (1) according to claim 5 characterized in that said time-measuring means are designed to determine a second brushing duration (D2i) during which an inappropriate movement of said toothbrush (1) is detected.

7. The electric toothbrush (1) according to claim 5, characterized in that said processing unit is designed to display on said display screen (10B) both a static representation (11) from the dentition of a user and a dynamic representation (12) in real time of a brushing progression of said dentition carried out by means of said toothbrush (1), said dynamic representation (12) being generated from position signals produced by said movement sensor.

8. The electric toothbrush (1) according to claim 7 characterized in that said processing unit is designed to freeze said dynamic representation (12) when said first warning signal is emitted.

9. The electric toothbrush (1) according to claim 7 characterized in that the static representation (11) of the dentition includes several dentition zones (Z1, Z2, Z3, Z4, Z5, Z6, Z7, Z8, Z9, Z10, Z11, Z12), said processing unit being designed to display on said display screen (10B) successive indications (F1) inviting the user to brush a respective one of said dentition zones (Z1, Z2, Z3, ZA, Z5, 76, Z7, Z8, Z9, Z10, Z11, Z12) for a respective predetermined time (TDi).

10. The electric toothbrush (1) according to claim 5 characterized in that said electric motor is connected to the processing unit so that the direction of rotation of the brushing roller (30) is automatically modified depending on position signals produced by said movement sensor.

11. The electric toothbrush (1) according to claim 1 characterized in that it includes a data exchange module designed to communicate by radio waves (9) with a terminal (10) provided with a command interface (10A) and a display screen (10B), said processing unit being at least partly formed by said terminal (10).
